(19) United States
(12) Patent Application Publication
(10) Pub. No.: US 2008/0165843 A1
(43) Pub. Date: Jul. 10, 2008

(54) Architecture for image compression in a video hardware

(75) Inventors: Ira Dvir, Rishon-LeZion (IL); Nitzan Rabinowitz, Ramat-HaSharon (IL)

Correspondence Address: Martin D. Moynihan;PRTSI, Inc., P.O. Box 16446, Arlington, VA, 22215, US

(73) Assignee: Human Monitoring Ltd., Givat HaShlosha (IL)

(21) Appl. No.: 12/003,934

(22) Filed: Jan. 3, 2008

Related U.S. Application Data
(63) Continuation-in-part of application No. 11/882,811, filed on Aug. 6, 2007.
(60) Provisional application No. 60/878,063, filed on Jan. 3, 2007.
(60) Provisional application No. 60/878,062, filed on Jan. 3, 2007.

(51) Int. Cl. H04B 1/66

(52) U.S. Cl. 375/240.01; 375/E07.093

(57) ABSTRACT

A method for compressing an image in a sequence of pseudo-video frames of a lower resolution than the image, comprising providing a video encoder fit for at least one of a spatial or temporal compression, providing an image, dividing the image into a plurality of partitions and encoding the partitions into pseudo-video frames by the encoder.

### RELATED APPLICATIONS

This application is a continuation-in-part of U.S. patent application Ser. No. 11/882,811 filed on Aug. 6, 2007, which claims the benefit under 35 USC 119(e) of U.S. Provisional Patent Applications Nos. 60/878,062 and 60/878,063, both filed on Jan. 3, 2007.

This application also relates to U.S. patent application Ser. No. 11/987,639 filed on Dec. 3, 2007.

This application is also being co-filed with the following PCT Patent Applications:
Attorney docket No. 37635 entitled “ARCHITECTURE FOR IMAGE COMPRESSION IN A VIDEO HARDWARE”.
Attorney docket No. 37636 entitled “ENTROPY DEFICIENCY BASED IMAGE COMPRESSION”.
Attorney docket No. 42975 entitled “COMPRESSING HIGH RESOLUTION IMAGES AS A LOW RESOLUTION VIDEO”.

The disclosures of all the cited applications are incorporated herein by reference.

### FIELD OF THE INVENTION

This invention, in some embodiments thereof, relates to image compression and decompression. Some embodiments relate to methods of compression an image as a video sequence, and decompression thereof.

### BACKGROUND OF THE INVENTION

The contemporary market of devices such as scanners, digital camcorders (video camera), digital cameras and camera equipped mobile handsets exhibits digital image capture capabilities with ever growing resolutions, ranging from a few mega pixels to hundreds mega pixels+.

The images captured by the devices typically have to be transferred to other devices such as handsets, phones, PCs or servers for operations such as viewing, processing, printing, analyzing or sharing.

Transferring a multi-mega pixels image may place a large demand on transmission and equipment and energy consumption. In many cases the image captures devices are portable and are limited with respect to battery capacity and size

Many of the image capture devices offer JPEG stills compression for low bit rates, and the high end devices offer TIFF or RAW (uncompressed) capturing for print quality. For 24 bit color images, JPEG of 6 bits per pixel is considered as reasonable print quality, and most of the devices offer JPEG capturing at 2-6 bpp (1:4 to 1:12 ratio to the 24 bpp RAW format).

Many of the image capture devices are capable of recording video using open standard formats. Typically the video is recorded after being compressed to the suitable standard (e.g., H.264, WM9, DivX or VP6) using dedicated hardware or some Media Processor.

A recent trend is to adopt the H.264 standard for video as, for example, NTT-DoCoMo of Japan, who set the specifications of a new standard 3G-324M for mobile phones which comprises a H.264 capability, and DivX and VP that adapt their respective standards to H.264.

For example, http://www.geniusdv.com/weblog/archives/on2_technologies_announces^{—}h264_support_in_flix.php, http://newteevee.com/2007/11/16/divx-mainconcept-h264/, and http://www.renesas.com/fmwk.jsp?cnt=press_release20070222.htm&fp=/company_info/news_and_events/press_releases.

The cited documents are incorporated herein by reference. All trademarks are the property of their respective owners.

### SUMMARY OF THE INVENTION

An aspect of some exemplary embodiments of the invention relates to compression of an image as a sequence of partitions thereof in a pseudo-video stream.

An aspect of some exemplary embodiments of the invention relates to decompression of an image compressed as partitions thereof in a pseudo-video stream.

In some embodiments of the invention, an existing hardware and/or software, or a design thereof, is utilized for the compression and/or decompression of the image.

In the specifications and claims, unless otherwise specified, the terms ‘software’, ‘program’, ‘procedure’ or ‘module’ or ‘code’ may be used interchangeably and denote one or more instructions executable by a computing apparatus (such as computer, processor, or a Digital Signal Processor (DSP)).

In the specifications and claims, unless otherwise specified, the term ‘pseudo-video stream’, ‘pseudo-video sequence’ or ‘pseudo-video’ denotes a sequence of frames in a video format spatially and/or temporally encoded from pictures and/or other data. In the context of the pseudo-video the term ‘temporal’ and inflections thereof relate to encoding of successive pictures as if they were time-successive pictures in a video recording.

According to an aspect of some embodiments of the present invention there is provided a method for compressing an image in a sequence of pseudo-video frames of a lower resolution than the image, comprising:

(a) providing a video encoder fit for at least one of a spatial or temporal compression;

(b) providing an image;

(c) dividing the image into a plurality of partitions; and

(d) encoding the partitions into pseudo-video frames by the encoder.

In some embodiments of the invention, at least one of a spatial or temporal compression comprises a spatial and temporal compression.

In some embodiments of the invention, dividing comprises using a processor to divide the image.

In some embodiments of the invention, the processor comprises at least a part of the encoder.

In some embodiments of the invention, the encoder and the processor comprise a part of an integrated circuit.

In some embodiments of the invention, the integrated circuit comprises an existing video compression apparatus or part thereof.

In some embodiments of the invention, the integrated circuit comprises a system-on-a-chip.

In some embodiments of the invention, the integrated circuit comprises a commercially available video compression apparatus or part thereof.

In some embodiments of the invention, the encoder is compliant with at least one of H.264, MPEG1, MPEG2, MPEG4, DivX, VP, QT, WM or VC scheme or other standard scheme.

According to an aspect of some embodiments of the present invention there is provided a method for integration of an image compression functionality in at least one of an apparatus or a design for video encoding of frames of a lower resolution than the image, comprising:

(a) providing a video encoding apparatus comprising a processor configured to execute a program; and

(b) modifying the apparatus to facilitate compression of a still image by the apparatus.

In some embodiments of the invention, modifying comprises modifying the program for the image compression.

In some embodiments of the invention, modifying comprises adding a code for the image compression.

In some embodiments of the invention, modifying comprises modifying pathways of data.

In some embodiments of the invention, modifying comprises modifying a memory allocation.

In some embodiments of the invention, modifying comprises at least one of adding an element, changing an element, deleting an element or replacing an element.

In some embodiments of the invention, the apparatus is a part of a system-on-a-chip.

In some embodiments of the invention, modifying maintains the original video compression functionality of the apparatus.

In some embodiments of the invention, at least the apparatus or the design is compliant with at least one of H.264, MPEG1, MPEG2, MPEG4, DivX, VP, QT, WM or VC scheme or other video standard scheme.

In some embodiments of the invention, the apparatus is a part of at least one of a cellular phone, a handset a camera, a scanner or any device capable of image acquisition.

According to an aspect of some embodiments of the present invention there is provided a method for integration in a video decoder a functionality for decompression an image compressed in frames of a pseudo-video sequence, comprising:

(a) providing a video decoder comprising a stored programming code; and

(b) modifying the code to facilitate image decompression from decoded video frames.

In some embodiments of the invention, modifying the code comprises adding a code for managing the decoder operation.

In some embodiments of the invention, modifying the code comprises adding a code for identifying frame characteristics.

In some embodiments of the invention, modifying the code comprises adding a code for constructing a decompressed image by tiling decoded frames.

In some embodiments of the invention, the decoder is a design of a decoder.

In some embodiments of the invention, the decoder is an existing a decoder.

According to an aspect of some embodiments of the present invention there is provided an apparatus for image compression in a pseudo-video sequence of frames of a lower resolution than the image, comprising:

(a) a video encoder configured to encode at least spatially or temporally a plurality of pictures in a sequence of compressed frames;

(b) a processor configured to execute a stored program or a part thereof, and

(c) wherein the program is configured to compress the image by the encoder.

In some embodiments of the invention, the program comprises a code configured to divide the image into pictures in a structure suitable for encoding by the encoder.

In some embodiments of the invention, the structure comprises a resolution suitable for encoding by the encoder.

In some embodiments of the invention, the program comprises a code configured to provide the pictures to the encoder.

In some embodiments of the invention, the program comprises a code configured to encode by the encoder information related to the sequence of frames.

In some embodiments of the invention, the information is used for decompressing the image from the encoded pictures.

In some embodiments of the invention, the apparatus comprises a system-on-a-chip.

In some embodiments of the invention, the encoder is compliant with at least one of H.264, MPEG1, MPEG2, MPEG4, DivX, VP, QT, WM or VC scheme or other video standard scheme.

In some embodiments of the invention, the apparatus is configured for video recording.

In some embodiments of the invention, the apparatus is at least implemented or suitable for implementation in a mobile device.

In some embodiments of the invention, the apparatus is a part of at least one of a cellular phone, a handset, a camera, a scanner or any device capable of image acquisition.

In some embodiments of the invention, the apparatus comprises an apparatus for image decompression of an image compressed in a pseudo-video sequence of frames of a lower resolution than the image.

According to an aspect of some embodiments of the present invention there is provided an apparatus for image decompression of an image compressed in a pseudo-video sequence of frames of a lower resolution than the image, comprising:

(a) a video decoder configured to decode frames into pictures from a pseudo-video sequence of compressed frames;

(b) a processor configured to execute a stored program or a part thereof, and

(c) wherein the stored program is configured to decompress the image by the decoder.

In some embodiments of the invention, the program comprises code to decode frames into pictures by the decoder.

In some embodiments of the invention, the program comprises code to decode frames into pictures by the decoder.

In some embodiments of the invention, the program comprises code to construct the pictures into a decompressed image.

In some embodiments of the invention, the image is constructed based on information extracted from the pseudo-video sequence of compressed frames.

In some embodiments of the invention, the apparatus comprises a system-on-a-chip.

In some embodiments of the invention, the apparatus is at least implemented or suitable for implementation in a mobile device.

In some embodiments of the invention, the decoder is compliant with at least one of H.264, MPEG1, MPEG2, MPEG4, DivX, VP, QT, WM or VC scheme or other video standard scheme.

In some embodiments of the invention, the apparatus is configured for video display.

In some embodiments of the invention, the apparatus is at least implemented or suitable for implementation in a mobile device.

In some embodiments of the invention, the apparatus is a part of at least one of a cellular phone, a handset, a camera, a scanner or any device capable of image acquisition.

In some embodiments of the invention, the apparatus comprises an apparatus for image compression in a pseudo-video sequence of frames of a lower resolution than the image.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the accompanying drawings, identical and/or equivalent and/or similar structures, elements, or parts that appear in more than one drawing are generally labeled with the same numeral in the drawings in which they appear. Dimensions of components and features shown in the figures are chosen for convenience or clarity of presentation and are not necessarily shown to scale.

FIG. 1 schematically illustrates a typical apparatus for video capture and compression suitable for exemplary embodiments of the invention;

FIG. 2 schematically illustrates an apparatus for compressing an image using a video compression apparatus, in accordance with exemplary embodiments of the invention;

FIG. 3 schematically illustrates an iMX31 apparatus for compressing an image using a video compression apparatus, in accordance with exemplary embodiments of the invention;

FIG. 4 schematically illustrates TMS320DM6446 apparatus for compressing an image using a video compression apparatus, in accordance with exemplary embodiments of the invention;

FIG. 5 is a schematic illustration of an image comprising lines (or columns) constructed into tiles, in accordance with exemplary embodiments of the invention; and

FIG. 5A schematically illustrates a plurality of apparatus encoding in parallel a plurality of lines, in accordance with exemplary embodiments of the invention.

### DESCRIPTION OF EMBODIMENTS OF THE INVENTION

An aspect of some exemplary embodiments of the invention relates to an integration of an of image compression (encoding) functionality into a video compression apparatus and/or a design thereof.

In some embodiments of the invention, the compression functionality comprises compression of partitions of the image as frames in a pseudo-video stream.

An aspect of some exemplary embodiments of the invention relates to an integration of a decompression (decoding) functionality into a video decompression apparatus and/or a design thereof.

In some embodiments of the invention, the decompression functionality comprises decoding (decompression) of a pseudo-video frames as partitions of an image.

In some embodiments of the invention, the compression and/or decompression apparatus and/or design thereof, comprise software and/or hardware, optionally comprising existing apparatus and/or design which are optionally commercially available.

In some embodiments of the invention, the integration of the compression and/or decompression functionality comprises software modification and/or addition. Optionally, the integration comprises modification of memory allocation or role. Optionally, the integration comprises modification and/or addition of data paths. Optionally, the integration comprises hardware modification and/or addition. In some embodiments, the integration alterations relate to at least one of image acquisition, image partitioning, and adaption to existing apparatus or design. In some embodiments of the invention, the integration of the additional functionality of image compression and/or decompression maintains the original capabilities of the apparatus or design thereof.

In some embodiments of the invention, the video apparatus is implemented in a portable device, such as cellular phone, handset (e.g., PDA, personal digital assistant) or digital camera. In some embodiments, the device is not necessarily portable, such as a scanner.

In the specifications and claims, unless otherwise specified, a device in which a video compression apparatus is implemented, or suitable for such implementation, is denoted as a ‘video device’.

In the specifications and claims, unless otherwise specified, the term ‘still image’ denotes one or more still images as opposed to video motion pictures

In the specifications and claims, unless otherwise specified, the term ‘resolution’ denotes the number of pixels and/or aspect ratio of an image or part or transformation thereof, such as n×m pixels (n columns by m rows, or vice versa).

In the following descriptions, unless otherwise specified, the term ‘video apparatus’ or ‘apparatus’ relates to an apparatus comprising hardware and/or software capable of video compression by spatial and/or temporal encoding, or a design thereof.

In the following descriptions, unless otherwise specified, the term ‘general purpose processor’ relates to a processor comprising versatile instructions set, such as x86 or ARMx (informally related to Intel Corporation and ARM Ltd., respectively).

The non-limiting section headings used herein are intended for convenience only and are not to be considered as necessarily limiting the scope of the invention.

### Video Apparatus Overview

In some embodiments of the invention, the video apparatus comprises hardware and/or software to compress video frames spatially and/or temporally (video encoding). In some embodiments of the invention, the video architecture and apparatus implements, at least partially, a standard video compression scheme such as H.264, MPEG1, MPEG2, MPEG4, DivX, VP, QT, WM or VC scheme or other video standard scheme.

In some embodiments of the invention, the video apparatus comprises one or more IC such as a dedicated IC (integrated circuit) and/or ASIC (application specific IC) and/or ASSP (application specific standard product) and/or FPGA and/or SoC (system on a chip).

In some embodiments of the invention, the apparatus comprises one or more processors, optionally as part of the ASIC or SoC, such as a core of a processor implemented as a cell, or otherwise, in an ASIC or SoC. Optionally, the processor is a general purpose processor. Optionally or alternatively, the processor is designed to enhance specific operations, such as video compression or image processing or signal processing (e.g., a DSP). Optionally, the apparatus comprises memory, such as ROM, PROM, volatile memory (e.g., RAM) or add-on memory (e.g. memory card). Optionally, at least a part of the memory is implemented in the circuit of the processor. Optionally, the memory comprises programs for the processor operation and/or for data storage.

In some embodiments of the invention, the apparatus comprises a video encoder that converts video images into a sequence of spatially and/or temporally compressed frames. Optionally the ASIC or SoC that comprises the processor comprises also the encoder or part thereof. In some embodiments of the invention, the encoder comprises a processor operating according to an encoding program. In some cases, the processor is a general purpose processor, such as an embedded core, or the processor is a general purpose DSP or a processor dedicated, at least partially, for encoding (and/or decoding). In some cases, the processor utilizes another processor, optionally with circuitry or instructions set capable and/or adapted for efficient and/or fast encoding, e.g., tight compression and/or fast compression. In some cases, the processor utilizes a hardware and/or firmware component adapted for efficient and/or fast encoding. In some cases, the encoder comprises a hardware and/or firmware component optionally adapted for efficient and/or fast encoding.

In some embodiments of the invention, the apparatus is configured to capture an image right off an image capture device (‘imager’) such as a CCD device or a CMOS device. Optionally or alternatively, the image is obtained via an intermediate apparatus. Optionally, the apparatus comprises the imager, such as a CMOS imager, optionally as a part of the ASIC or SoC.

In some embodiments of the invention, the apparatus comprises an image processing unit (IPU), for example to convert the image to a different format or to interface with the imager. Optionally, the IPU is a part of the ASIC or SoC. Optionally, the apparatus comprises other units such as control unit, peripheral interfaces, or interfacing with the imager or a video device.

In some embodiments of the invention, the apparatus one or more IC comprises an existing video apparatus or part thereof. Optionally, the apparatus IC comprises a commercially available video compression apparatus or part thereof.

In some embodiments of the invention, the apparatus pre-process the image by operations such as sharpening, changing the image gamma (brightness proportions) or modifying the brightness or contrast. Optionally, the apparatus modifies the image format to a format suitable for the encoder, for example, from a BAYER color format (such as Green-RED-Green-Blue pixels cells) to YUV (4:2:2 or 4:2:0 luminance color pixels cells). Optionally, the pre-process is performed by the processor using image processing programs or by a dedicated unit such as IPU.

### Image and Video Resolutions

In some embodiments of the invention, the video apparatus in a video device is capable, or optionally limited, to handle an image of a D1 resolution (about a standard TV resolution, see later) or CIF (352×288). Optionally, the resolution is lower than D1 or CIF, such as 1/2D1 or 2/3D1 or QCIF (176×144). Optionally, the resolution is higher than D1, such as HDTV. Typically, without limiting, the video apparatus is bounded to a resolution compatible with commercial display equipment such as television set.

In some embodiments of the invention, the resolution of a still image implemented in a video device is 1M pixels or higher, such as 3M, 5M, 10M or an intermediate value. Optionally, the image resolution is above 10M pixels, for example 100M pixels or above (such as in scanners), or any value between 10M pixels and 100M pixels. In some cases, the apparatus modifies the image resolution or aspect ration, for example, increasing the image resolution by interpolation. The image modification may be carried out by a processor using image processing programs or by other manners such as by a dedicated unit, for example an IPU.

In some embodiments of the invention, and generally without limiting, the still image resolution is higher than the video resolution, optionally by an order of magnitude or more than the resolution of the video.

### Operation Overview

Considering the resolution gap between still image and a video image, a unique feature of some embodiments of the invention comprises exploiting efforts made by the industry in providing efficient apparatus for video compression and decompression in order to compress and/or decompress a high resolution still image. In some embodiments of the invention the exploitation comprises integration and/or modification of a program code and/or a hardware unit in an existing video apparatus or design, typically (without limiting) with minimal consumption of resources of the apparatus in terms such as memory, processing time, size and/or power consumption, and without a discernable effect on the performance of the existing apparatus.

In some embodiments of the invention, the video apparatus, optionally using a processor, divides the image into a plurality of partitions, or sub-images, or pictures (hereinafter ‘tiles’). Typically, without limiting, a tile resolution is adapted to fit the capability of the video apparatus, for example, a D1 or CIF resolution. Each tile or a copy thereof, is provided to a video encoder, e.g., is transferred to, or read by, the video encoder that incorporates it into the video sequence as a spatially and/or temporally compressed frame. Preferably, without limiting, the video apparatus constructs and encodes the tiles into a sequence of frames according to an industry standard scheme (e.g., H.264), providing a pseudo-video stream which may be decoded, at least partially, by standard decoders (e.g., H.264 decoder or compatible decoders).

In some embodiments of the invention, the pseudo-video sequence comprises GOP (group of pictures) comprising I-frames (spatially compressed). Optionally, a GOP comprises IP sequence, that is, a spatially compressed frame followed by a temporally compressed frame (relative to a preceding one). Optionally, other sequences are used such as IPP or IPPP or IPBP, (where a B-frame is temporally compressed based on preceding and following frames) or other sequences as known in the art. Optionally, the GOP structure is according to a setting in or for the encoder, optionally by the processor. Typically, without limiting, depending on the similarity between consecutive tiles, a temporal compression yields better compression than spatial compression. However, in some embodiments of the invention, other considerations are taken into account for the structure of a GOP, such as encoding and/or decoding time or resources (e.g., buffering frames or tiles for comparison), or decoder operation or decoding stability (e.g., skipping to the next I-frame after a corrupted frame).

In some embodiments of the invention, a tile is provided to the encoder two or more times, yielding a frame in increasing refinement of the respective encoded image tile (layers). For example, a tile is provided to the encoder which compresses it spatially as optionally a lossy I-frame. Subsequently, the same tile is provided again to the encoder which evaluates the difference between the tile and a decoded I-frame, wherein the difference is encoded in a P-frame following the I-frame (temporal compression), thus providing a two-layer GOP (group of pictures) comprising an IP frames sequence with increasing refinement or quality (the encoded difference in the P-frame being a refinement or of better quality over the initial compressed I-frame). A further refinement or quality layer is obtained by providing the tile again to the encoder which evaluates the difference between the tile and the decoded sum of the I-frame and P-frame, wherein the difference is encoded in a P-frame following the previous P-frame, providing a three layer GOP comprising of IPP frames sequence. Similarly, a multi-layer compassion can be achieved with more quality layers.

It should be noted that, typically without limiting, the encoder is set for the structure of the GOP to produce, irrespective to the content of the provided information, so that spatial and/or temporal compression and refinement layers are achieved by the native operation of the encoder.

In some embodiments of the invention, when the imager or the apparatus enable to capture separate lines or columns, or individual pixels, the apparatus may form tiles comprising contents which may enhance the subsequent compression and/or image quality.

For example, assembling pixels to form a tile of the same of similar contents (e.g., color) would enable the encoder to achieve high spatial compression ratio or high visual quality with satisfactory compression due to the small variance of the pixels. As another example, assembling pixels to form tiles with similar contents and providing the tiles consecutively to the encoder would enable the encoder to achieve high temporal compression ratio due to the small (‘temporal’) difference between the tiles.

The methods for compression an image in a video sequence are optionally, at least partly, as described in U.S. application Ser. No. 11/882,811 filed on Aug. 6, 2007, entitled “COMPRESSING HIGH RESOLUTION IMAGES IN A LOW RESOLUTION VIDEO”, and in a PCT application attorney docket No. 42975 entitled “COMPRESSING HIGH RESOLUTION IMAGES IN A LOW RESOLUTION VIDEO”, the disclosures of which are incorporated herein by reference.

### Schematic Video Apparatus

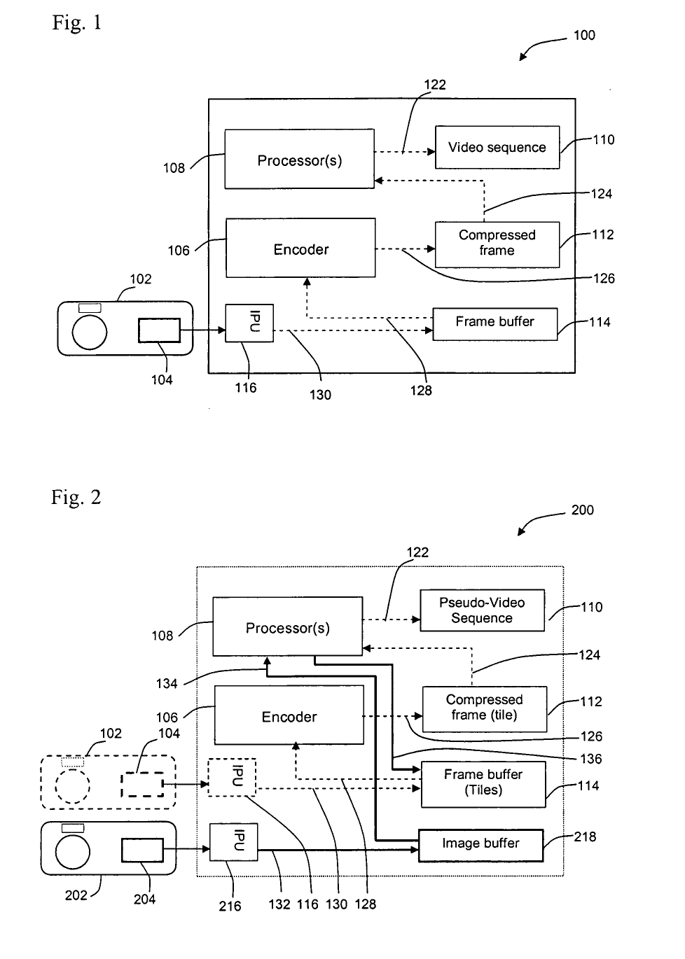

FIG. 1 schematically illustrates a typical apparatus 100 for video capture and compression suitable for exemplary embodiments of the invention. Apparatus 100 or variations thereof may be found in video devices such as cameras, cellular phones or handsets.

In some embodiments of the invention, a video camera 102, which may be part of the video device or an add-on or a connected device, comprises an imager 104 of a type such as CMOS or CCD. An Image Processing Unit (IPU) 116 captures the sequence of images (frames) from imager 104 and transfers the images to a frame buffer 114 (as indicated by dashed arrow 130), optionally after preprocessing the image. In some embodiments a video encoder 106 reads the image in buffer 114 (as indicated by dashed arrow 128) and compresses the frame spatially and/or temporally into a compressed (encoded) frame 112 (as indicated by dashed arrow 126). In some embodiments a processor 108, using code comprised in apparatus 100 and/or connected to apparatus 100, reads compressed frame 112 (as indicated by dashed arrow 124) and assembles compressed frames 112 into a video sequence 110 (as indicated by dashed arrow 122). In some embodiments instead of encoder 106 reading buffer 114, processor 108 provides the image in buffer 114 to encoder 106.

In some embodiments processor 108 controls encoder 106, such as setting the image resolution, setting the GOP structure (e.g., III . . . or IP . . . or IPP . . . , etc.), setting compression parameters or other controls according to the design of apparatus 100. In some cases, the control of apparatus 100, possibly using processor 108, is affected by user input in a video device in which apparatus 100 is implemented, for example, by the numeric keyboard of a cellular phone. In some embodiments the frame resolution in frame buffer 114 is limited by camera 102 or imager 104 or the capability of encoder 106, such as D1 or CIF. In some cases, the frame resolution in frame buffer 114 is according to a preprocessed image from camera 102, possibly of a lower or larger resolution than that of imager 104.

In some embodiments, IPU 116 is not present and processor 108 captures the image from imagers 104. Alternatively, in some cases, the image is captured from imager 104 by encoder 106. Alternatively, the image is captured from imager 104 by processor 108 and encoder 106. In some cases, device 100 does not comprise frame buffer 114. In some embodiments, encoder 106, and possibly other components (not shown) are controlled by processor 108 using code stored in apparatus 100 or outside apparatus 100.

In some embodiments, processor 108 comprises encoder 106, or part thereof. Possibly, encoder 106 comprises processor 108. In some cases, encoder 106 and processor 108 are the same operational unit.

The components of apparatus 100 are intended to illustrate the sequence of operation wherein apparatus 100 may comprise other components and may be fabricated in various manners. For example, processor 108 and encoder 106 may be fabricated in the same IC, or processor 108 may comprise a plurality of processors such as general purpose processor (such as RISC CISC architecture), an image processing processor or a DSP.

In some embodiments of the invention, all or most of the operations discussed are controlled by processor, or a plurality of processors, 108.

### Schematic Integration of Image Compression in a Video Apparatus

FIG. 2 schematically illustrates an apparatus 200 for compressing an image using a video compression apparatus, in accordance with exemplary embodiments of the invention.

In some embodiments of the invention, apparatus 200 is similar to, or a modification of, video compression apparatus 100 of FIG. 1, where some of the data paths modifications are indicated by bold arrows and the dashed arrows are according to apparatus 100.

In some embodiments of the invention, the still image size (resolution) is higher than video frame buffer size, as discussed earlier, and frame buffer 114 size is not sufficient to store the image. In some embodiments of the invention an additional memory buffer 218 is added or allocated to store the still image. In some embodiments, this is used to preserve the architecture of the video apparatus.

In some embodiments of the invention, a stills camera 202, which may be part of the video device or an add-on or a connected device, comprises an imager 204 such as of CMOS or CCD technology. Optionally, camera 202 and/or imager 204 are the same or part or the same unit as camera 102 and/or imager 104, respectively, as further discussed below.

An image processing unit (IPU) 216 captures the image from imager 204 and transfers the image to image buffer 218 (as indicated by arrow 132).

Processor 108 reads the image in image buffer 218 (as indicated by arrow 134) and divides the image to tiles in a size compatible with encoder 108. Each tile is stored in frame buffer 114 (as indicated by arrow 136), mimicking a frame captured from a video camera.

In an exemplary embodiment of the invention, the tiles in frame buffer 114 are now processed as frames according to device 100 as described above, and compressed as frames in pseudo-video (rather than regular video stream) sequence 110, according to settings of the apparatus 200, at least partially as described for apparatus 100 above.

In some embodiments of the invention, imager 204 and imager 104 are compatible with each other so that the same interface (such as IPU 116) may be used for both imager 104 and 204. Optionally, imager 104 and 204 are part of the same unit, or are identical or implemented as the very same unit. For example, the video image comprises only a part of the imager size/resolution, or the image captured from the imager is downsized, e.g., by sub-sampling and optional interpolation, to match the capability of encoder 106. In such cases, optionally, image buffer 218 and frame buffer 114 comprise the same unit. For example, frame buffer 218 is partitioned with a partition for the still image and a partition for the video frame, so that an additional image buffer 218 is not necessary. Optionally, elements such as IPU 116 are modified or replaced by IPU 216 for compatibility with imager 204 and/or 104.

In some embodiments of the invention, imager 204 may be accessed directly, e.g., by processor 108, to obtain the tiles right off imager 204 so that image buffer 218 is not present and/or not used. Optionally, IPU 116 can capture the still image from imager 204. Optionally, IPU 116 is similar or identical to IPU 216 or compatible with imager 204 so IPU 216 is not present. Optionally, no IPU is present, for example, when processor 108 accesses imager 204.

In some embodiments of the invention, encoder 106 and processor 108 are not modified between apparatus 100 and apparatus 200. Also, in some embodiments of the invention, the code for video processing is maintained between apparatus 100 for video compression and apparatus 200 for still image compression. Optionally, the existing code of processor 108 of apparatus 100 is modified or adapted, e.g., rewriting code sections or adding code, to cooperate or synchronize with the additional code for image partitioning and tile handling of apparatus 200. As such, the video processing of apparatus 100 is substantially indifferent to the modification of apparatus 100 into apparatus 200, or the integration of the still image compression in existing apparatus 100. Preferably, without limiting, in some embodiments of the invention, modification of apparatus 100 into apparatus 200 does not hamper the capabilities of video operation of apparatus 100 (such as video recording), at least when still image compression is not active. Preferably, without limiting, in some embodiments of the invention, modification of apparatus 100 into apparatus 200 does not increase, or insignificantly increases, the size of equipment in the video device where apparatus 100 is implemented or may be implemented, and the energy consumption is not increased beyond the operation of the image compression (which is typically similar to the regular operation of the video operation).

In some embodiments of the invention, for example in case the processing power of apparatus 100 is not sufficient for operations involved in still image compression, and/or may not be sufficient for additional options or possible add-on features, the processor in the video apparatus (e.g. 108) is replaced with a more powerful one (such as an upgraded processor core, optionally with added memory) in order to carry out and/or manage and/or synchronize the still image compression. Optionally or alternatively, an additional processor core (optionally with additional memory) is implemented in the IC of the video apparatus, or an additional processor (optionally with additional memory) is connected to the video apparatus. The additional components may be connected to apparatus 100 via interface ports (not shown).

The variations and alternatives as described above illustrate various embodiments for the adaptation of video apparatus 100 to provide the functionality of still image compression. Optionally, other variations may be used according to the capabilities and limitations of apparatus 100 and/or requirements of the functionality of still image compression.

It should be noted that preferably, without limiting, in some embodiments of the invention, the integration of still image compression in apparatus 100 may comprise only a code addition and/or modification and optionally a minor apparatus adjustment or addition such as different memory allocation or additional memory.

It should be noted that preferably, without limiting, in some embodiments of the invention, the integration of still image compression in apparatus 100 may comprise software techniques for fast operation and/or efficient resources utilizations such as in terms of memory and energy consumption. For example, using pointers to access data rather than copying (e.g. reading a tile right off the imager by the encoder using pointers), or using circular or alternating buffers to save memory space, or using the processor instructions set to move data in chunks rather than by bytes or processor words.

In some embodiments of the invention, the discussion regarding the integration of still image compression in a video apparatus relates, at least partly, to a design phase rather than to actual apparatus or components. For example, modifying an FPGA program, or modifying electronic circuit drawings for subsequent production.

In some embodiments of the invention, the additional code for compression of the still image comprises code that provide information pertaining to the structure and sequencing of the frames in pseudo-video sequence 110, as well as additional data pertaining to the image. For example, headers for navigation and identifying sections or particular data in pseudo-video sequence 110, indexing of tiles according to their position in the image or tagging of layers so that tiles of a particular layer may be accessed (e.g., for decoding in a particular resolution or refinement). The additional information is denoted as ‘meta-data’ to distinguish it from the encoded tiles. In some embodiments of the invention, the meta-data is arranged in a tile format so that encoder 106 compresses the meta-data and processor 108 assembles the meta-data as a frame in pseudo-video sequence 110, optionally irrespective to the fact that the tiles are not images or part thereof. Optionally, the meta-data tiles comprise thumbnail images of the still image, such as for a future preview of the compressed data

Pseudo-video sequence 110 may be transmitted or transferred to another device. Optionally or alternatively, pseudo-video sequence 110 may be stored in a file, such as HMP file as discussed later. Pseudo-video sequence 110 may be subsequently decoded to provide a decompressed image, optionally according to the meta-data tiles embedded therein, as discussed below.

### Alternative Image Sources

In some embodiments of the invention, video apparatus such as apparatus 100 may be modified to integrate a still image compression such as apparatus 200, wherein the still image input is not from an imager such as imager 104 or 204, but rather, from other sources.

In some embodiments of the invention, the image source is a file such as in a bit-map (RAW) format or other image presentations formats (e.g. TIFF or BMP, JPEG). Optionally, the file is stored on the same device as the video apparatus. Optionally, the file is stored on add-on or connected storage media (e.g., memory card, USB storage device, portable hard-disk). In some embodiments of the invention, the video apparatus such as apparatus 200 is configured, optionally by adaptation of a processor (e.g. processor 108) program to access the file such as via an interface, existing or provided, to a file system. For example, API (application programming interface) of a real-time kernel, RTOS (real time operating system), or other operating systems.

In some embodiments of the invention, the image source is via a transmission link such as by the Internet or some wireless links. In some embodiments of the invention, the video apparatus such as apparatus 200 is configured, optionally by adaptation of a processor (e.g. processor 108) program to access the communication link such as via an interface, existing or provided, to an underlying hardware-software layer (e.g., virtual port, socket). For example, API (application programming interface) of a real-time kernel, RTOS (real time operating system), or other operating systems. Optionally, the image is accessed from an intermediate buffer of the communication link.

In some embodiments of the invention, the video apparatus such as apparatus 200 is configured for a plurality of image inputs. For example, the apparatus may access both an imager or a file, or an imager or a link, or file and link, or other combinations.

### Integration Techniques

In accordance with the discussions above, at least partly, various techniques may be used to integrate a still image compression functionality in an existing video apparatus or design.

In some embodiments of the invention, the integration comprises changing a program for a processor operation, for example, ‘burning’ a new program on a PROM component, or downloading a program into an EEPROM. Optionally, changing the program comprises replacing a memory unit with a new unit comprising the new program.

In some embodiments of the invention, the integration comprises modifying an existing design of the video apparatus, for example, adding and/or changing memory, registers, changing data pathways and/or control or changing and/or adding other units such as imager interface unit or IPU. Optionally, the design is a custom or original design comprising a functionality for both video recording and image compression. Optionally or alternatively, the design is based on previous design, such as circuit diagrams and/or design drawings.

In some embodiments of the invention, when the apparatus comprises an FPGA or other programmable devices, the integration optionally comprises modifying the design by modifying the logic program or high level program (HDL) such as Verilog or VHDL, and consequently manufacturing the apparatus comprising the modifications.

In some embodiments of the invention, the integration comprises minor modifications in the apparatus and/or design thereof, and the implementation may be an insignificant part of fabricating a new version of an IC, and in the case of programmable devices the modification involves mostly a design program modification and compilation.

In some embodiments of the invention, the design may be implemented in the design of a new (or new model) of a video device such as a cellular phone. Optionally or alternatively, the design may be used to modify an existing design or a video device. In some embodiments of the invention, an existing video device is upgraded to include the still image compression by replacing a unit (such as chipset), modifying a program and/or adding a unit (as discussed above), or by an add-on unit.

In some embodiments of the invention, the modifications are subject or directed, at least partly, by accessibility of the video apparatus or the components of the video device. For example, if the chipset comprising the video functionality is removable (at least cost effective removable), or if there is suitable place for adding or replacing a component, or if there is an interface with i/o pins or contacts to connect additional or alternative unit, or if the processor code is re-programmable (e.g. EEPROM).

### Video Apparatus Example I

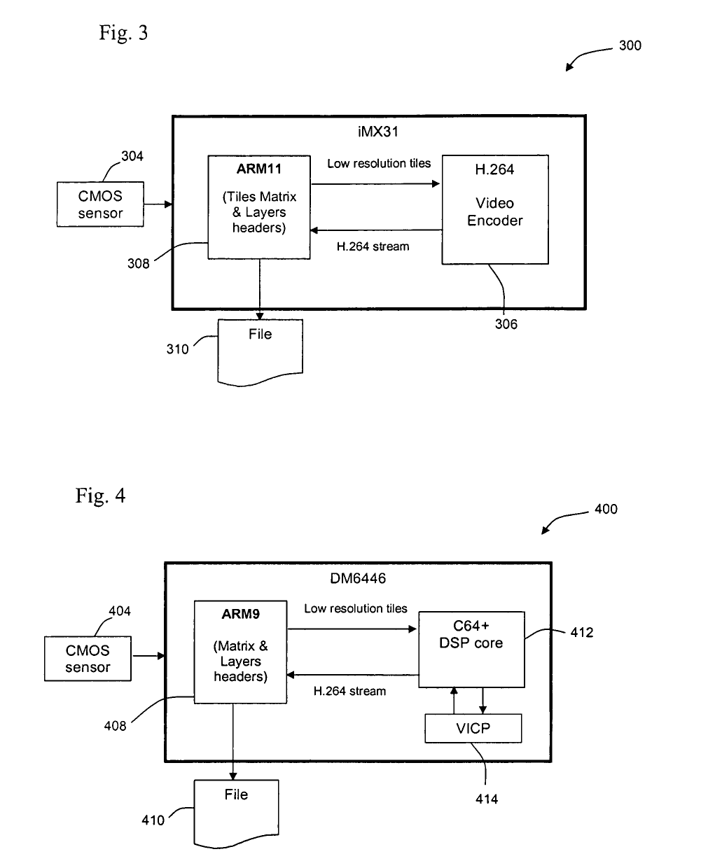

FIG. 3 schematically illustrates an implementation of Freescale Semiconductor of iMX31 apparatus 300 for compressing an image using a video compression apparatus, in accordance with exemplary embodiments of the invention. Apparatus 300 is a simplification of a device described in Freescale Semiconductor i.MX31 and i.MX31L Multimedia Applications Processors Product Brief (Document Number. MCIMX31PB Rev. 1, February 2006), the disclosure of which is incorporated herein by reference.

The iMX31 architecture comprises an ARM11 (RISC processor) core 308 and a H.264 video encoder 306 capable of encoding frames in D1 or lower resolution.

With reference to and comparison with apparatus 100 and 200 of FIGS. 1 and 2 and their respective operation, in some embodiments of the invention ARM11 core 308 receives a high resolution still image from a CMOS (or CCD) imager 304. The image is received at ARM11 core 308 in a BAYER format or YUV format. ARM11 core 308 coverts the image to a format suitable for an H.264 encoder 306, such as 4:2:2 or 4:2:0 planar organization.

Since the high resolution of the still image is not compatible with H.264 resolution, ARM11 core 308 partitions the high resolution image into tiles of maximal D1 resolution each. Optionally, such when memory of the IMX31 system is limited, in order to reduce memory storage of tiles in the iMX31 apparatus 300, the tiles are constructed in a lower resolution, such as 1/2D1.

The tiles partitioned by ARM11 core 308 are encoded by encoder 306 as pseudo-video frames and returned to ARM11 core 308 which assembles them into a pseudo-video sequence file 310.

In some embodiments of the invention, encoder 306 is set by ARM11 core 308 to use I-Frames only. Optionally, H.264 encoder 306 is set for other GOP (Groups or pictures) such as IPIP or IPPPIPP or other GOP structures, optionally to achieve greater temporal compression as discussed above

In some embodiments of the invention, when a multi-layer video sequence (multiple frames with different refinement) is required, for example, to provide scalable resolution for devices with limited resources or display resolution, ARM11 core 308 feeds H.264 encoder 306 with duplicates of a tile, and H.264 encoder 306 constructs them as difference frames in the pseudo-video stream, as discussed above. For example, when a dual-layer is called for, ARM11 core 308 provides H.264 encoder 306 with each tile twice, and H.264 encoder 306 constructs them as one I-Frame (spatially compressed) and one P-Frame (temporally and/or spatially compressed). When a triple-layer is called for, ARM11 core 308 feeds H.264 encoder 306 three times with each tile, and H.264 encoder 306 constructs the tiles as one I-Frame and two P-Frames.

In some embodiments of the invention, ARM11 core 308 adds tiles comprising meta-data as described above (with reference to FIG. 2). Optionally, the pseudo-video stream is stored as a file, optionally as EXIF (e.g. EXIF2.2) file or a similar exchangeable format (see also below).

### Video Apparatus Example II

FIG. 4 schematically illustrates a Texas Instruments TMS320DM6446 (‘DM6446’) apparatus 400 for compressing an image using a video compression apparatus, in accordance with exemplary embodiments of the invention. Apparatus 400 is a simplification of a device described in Texas Instruments TMS320DM6446 Digital Media System-on-Chip (SPRS283E—December 2005—Revised March 2007), the disclosure of which is incorporated herein by reference.

The DM6446 architecture comprises an ARM9 (RISC processor) core 408, a C64+ DSP core 412 and a video and imaging coprocessor (VICP) 414.

With reference to and comparison with apparatus 100 and 200 of FIGS. 1 and 2 and their respective operation, in some embodiments of the invention ARM9 core 408 receives a high resolution still image from a CMOS (or CCD) imager 404. ARM9 core 408 partitions the image into tiles which are sent to DSP core 412 for encoding into a compressed pseudo-video sequence, where DSP core 412 utilizes VICP 412 to accelerate the coding.

The tiles encoded by DSP core 412 and VICP 412 as video frames are returned to ARM9 core 408 which assembles them into a pseudo-video sequence file 410.

The options, transformations and capabilities described for apparatus 300 of FIG. 3 are, at least partly, applicable to apparatus 400 and are not repeated for brevity and clarity. For example, formatting the captured image or a multi-layer pseudo-video.

### Scanner

In some embodiments of the invention, a row (or column) oriented devices such as scanners that provide a large and/or high resolution image one by one row (or a few rows at a time) are adapted with a video compression apparatus to compress the provided large still image while saving or reducing expensive memory space for storing or buffering the image and/or provided lines (or columns). Using an ‘on-the-fly’ row compression as discussed below saves a storage area which in some cases may comprise several to tens or hundreds kilo-bytes.

In the following discussion a scanner represents also other devices that provide data progressively.

With reference to apparatus 100 or 200 of FIG. 1 or 2, respectively, as the scanner advances over the image, it provides a row to the apparatus. The apparatus, e.g., using a processor, ‘folds’ the row or part thereof into a tile which is subsequently compressed as described above, for example, by storing it in image buffer 114 for compression by encoder 106.

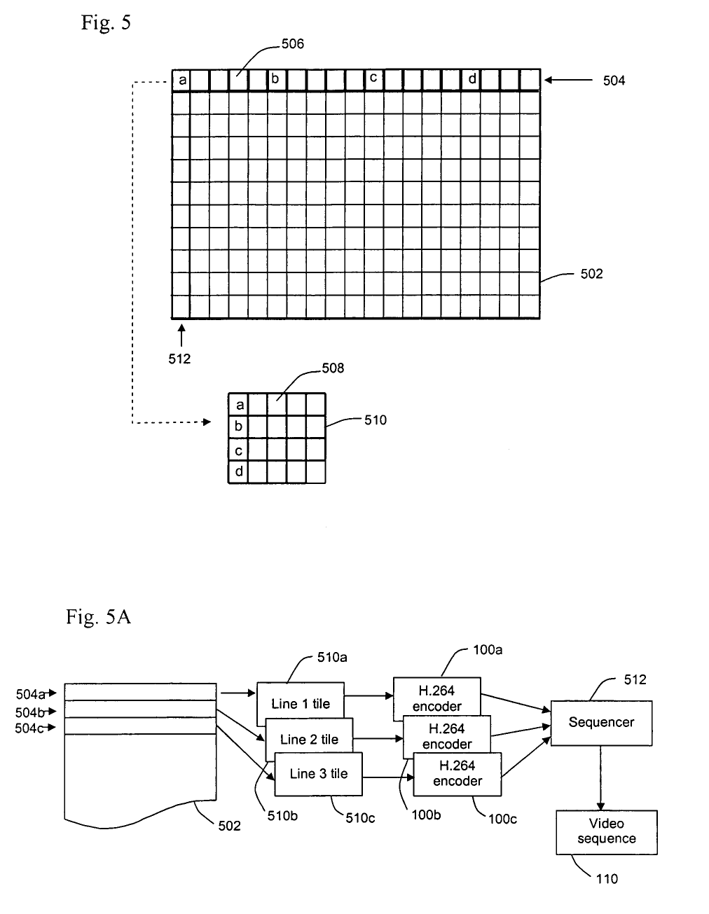

FIG. 5 is a schematic illustration of an image 502 comprising rows 504 (or columns 514) constructed into tiles 510, in accordance with exemplary embodiments of the invention. The illustrated rows 504 (or columns 514) are short relative to typical lengths of hundreds or thousands of pixels for clarity purpose, and may illustrate a remaining portion (residue) after the rest of the row (or column) was processed, as discussed below.

As the scanner provides pixels 506 in row 504, the processor, e.g., processor 108, folds pixels 506 to form tile 510 comprising of corresponding pixels 508 compatible with encoder 106 (labels ‘a’-‘d’ indicate the correspondence of the pixels). Optionally, row 504 comprises more pixels than suitable for encoder 106, and therefore row 510 is constructed into tile 510 and encoded in a plurality of consecutive operations. Optionally, a row or a residue thereof after processing of earlier pixels, comprises insufficient pixels to form a rectangular tile, so the tile is fed to encoder 106 in a non-rectangular form or, alternatively, tile 106 is padded with non-visual pixels or the padded pixels are indicated in the meta-data (as described above), or by additional pixels from the following row or rows.

In some embodiments of the invention, a scanner may provide a plurality of rows at a time, so that the scanner may be equipped with a corresponding number of compression apparatus (optionally sharing some components such as a processor). Optionally, each compression apparatus handles a separate row in a parallel operation. The plurality of tiles from the corresponding rows are arranged, e.g., by processor 108 or additional processor, consecutively in the pseudo-video sequence, or optionally or alternatively, the meta-data keeps track of the order for a subsequent decompression.

Optionally or alternatively, such when the apparatus is fast enough relative to the scanning rate, one apparatus may be used to compress the plurality of rows or part thereof. For example, if the scanner provides 8 rows at a time, 2 instances of the apparatus may be used, each handling 4 rows. The compression apparatus folds the plurality of rows into tiles, similar to as discussed above, and the meta-data keeps track of the tiles organization for proper subsequent decoding.

In some embodiments of the invention, the operations described for row 510 apply as well to column 512 in a device that provides columns instead of rows.

FIG. 5A schematically illustrates a plurality of apparatus 100a-100c similar to apparatus 100 of FIG. 1, encoding in parallel a plurality of rows 510a-510c, in accordance with exemplary embodiment of the invention. As the scanner provides rows 510a-510c, processors in 100a-100c (or other processor or processors) fold sections of rows 510a-510c into tiles 510a-510c, respectively, and provide the tiles for encoding in video apparatus 100a-100c, respectively. The encoded tiles 510a-510c (frames) are fed into a sequencer 512 which takes care of proper sequencing of the frames in pseudo-video sequence 110, similar or equivalent to pseudo-video sequence of apparatus 100 or 200 of FIG. 1 or 2, respectively.

In some embodiments of the invention, the operations described above apply as well, at least partially, to other devices that provide, or can provide, rows (or columns) separately. For example, a CCD typically provides an image in a row-by-row sequence, and an image in a CMOS imager may be accessed randomly, enabling to capture a sequence of rows or columns.

The apparatus and operations discussed above may be useful for portable scanners or similar devices.

It should be noted that contemporary image compressions methods that work on blocks of n×n pixels require obtaining and storing at least n rows, such as JPEG that operates on blocks of 8×8 and requires storing of 8 rows, whereas the approach described above can dispense with such a large and expensive storage which may reach several to tens or hundreds kilo-bytes.

### Pseudo-Video (HMP) File

In some embodiments of the invention, the tiles are stored as sequential frames with meta-data that keeps track or the location of a tile in the image (indexing). When multi-layer compression is used, the meta-data keeps track also to which layer the frames belong. Optionally, the meta-data comprises thumbnails of the image or part thereof, optionally in a plurality of resolutions.

In some embodiments of the invention, the meta-data comprises one or more headers that identify the type of information and respective location in the sequence. For example, in a known location (e.g. first frame or fixed number of first frames) is a header that identifies in which frame begins a sequence of image frames, or identifies the number of layers in the sequence and or the location of the last image frame, after which are located more meta-data frames.

In some embodiments of the invention, the pseudo-video sequence is stored in a file (‘HMP’ file) in a structure such as, or similar to, EXIF or XMP or IPCT or other exchangeable format which comprises additional meta-data.

### Decoding (Decompressing)

In some embodiments of the invention, a pseudo-video sequence such as stored in a HMP file may is decoded (decompressed, extracted) and presented in a presentation device such as a DVD player, a printer or a cellular phone.

In some embodiments of the invention, an existing video decoder is used, such as a H.264 decoder or a DivX decoder. The decoder, optionally comprising hardware and/or software, decodes the video frames back to the corresponding decompressed tiles and meta-data.

In some embodiments of the invention, an existing decoder is integrated with, or synchronized with, an additional apparatus comprising software and/or hardware that manages or controls the operation of the decoder (‘de-sequencer’). For example, when the first frame is an encoded meta-data header, the de-sequencer directs the encoder to decode the first frame only, where the decoded header is optionally stored separately, e.g., in a buffer. Consequently, based on the header contents such as locations of meta-data frames in the pseudo-video sequence, the decoder is controlled to decode frames holding meta-data such as indexing of tiles and layers identification, optionally storing them in a memory.

In some embodiments of the invention, based on the meta-data that characterize the frames, the de-sequencer controls the decoder to decode the image tiles frames back to the corresponding decompressed tiles. The de-sequencer arranges (or tiles, or combines or constructs) the decoded tiles in their corresponding location in the image, optimally modifying the tiles formatting, thus constructing a decompressed image in a desired format such as an RGB bitmap or YUV. Optionally, the decoder, or an accompanying software and/or hardware, post-process the decompressed image, using operations such as de-blocking, sharpening or smoothing.

In some embodiments of the invention, a custom decoder comprising a de-sequencer and comprising hardware and/or software is used to decompress the image in the HMP file.

In some embodiments of the invention, the de-sequencer apparatus may be integrated in an existing decoder in a similar manner that the still image compression apparatus is integrated in a video apparatus as described above. For example, modifying the design or code of the decoder, or if the decoder comprises an FPGA modifying the program or logic, or changing memory allocation or adding memory.

In some embodiments of the invention, the de-sequencer or the custom decoder is of a small size or volume and may be implemented in an ASIC and/or firmware (e.g. ROM or PROM and/or a processor core as a cell). Optionally, the de-sequencer software may be executed on a processor comprised in the presentation device. Optionally, the custom decoder may be used as an add-on unit in a presentation device.

In some embodiments of the invention, the compression apparatus and the decoding apparatus are comprised in the same unit or system, for example, in the same SoC or the same program.

In some embodiments of the invention, the HMP file decoder may be implemented in presentation devices such as TV-Set, TV set-top box, DVD player, digital camera, cellular phone, a handset, a printer or in a computer to display the image on the computer monitor.

### Potential Benefits

In some embodiments of the invention the still image encoded in a pseudo-video sequence is efficiently compressed, optionally due to the pseudo-temporal and/or pseudo-motion compression of the video scheme, such as H.264. Typically the sequence typically has a smaller volume relative to a JPEG (or optionally other schemes such as JPEG2000) of similar visual quality, or of a better visual quality compared to JPEG (or optionally other schemes such as JPEG200) of similar volume.

The compressed image in a pseudo-video sequence, optionally stored in a file (such as HMP file), may be transmitted in a low bit-rate or narrow bandwidth and provide an appropriate and/or sufficient visual quality. On the other hand, a JPEG or JPEG2000 compressed image would require a higher bit rate link to send the image in a comparable time and/or visual quality, or alternatively would require a longer time and/or provide lower visual quality.

Data sent over a communication link may be damaged in one or more of the data items (e.g., byte or packet) as a result of errors in the link or receiving side. Whereas still images compressed with methods such as JPEG or JPEG2000 are corrupted due to one or more errors, still image compressed in a pseudo-video such as according to H.264 is robust and can endure and overcome errors or conceal the errors, with no effect, or minor effect, on the visual quality of the transmitted image.

Typically technologies for transmission of video streams are mature and offer various implementations and integrations with other products, including integration with DRM (Digital Rights Management), in many cases contrary to the availability and quality of products and technologies related to for still images.

Considering the above, in some embodiments of the invention, compressing a still image in a pseudo-video stream may be advantageous in transmission reliability and/or security over other compression methods such as JPEG or JPEG2000.

In some embodiments of the invention, the apparatus for encoding (compression) is readily available (and expected to proliferate) in many video devices such as cellular phones, digital cameras and camcorders. With the availability of the video apparatus, the integration of the still image into the existing devices requires only small modification that would not increase (or negligibly increase) the cost and/or size and/or volume of the devices. Optionally, in some cases, the still image compression apparatus and/or software may be implemented as an add-on unit to the devices such that the devices are not affected. Optionally or alternatively, future devices may be implemented with modifications such as or similar to embodiments of the invention so they are ready for efficient video and still compression.

In some embodiments of the invention, compressing the image in a multi-layer scheme allows sending or presenting the image in a size and/or resolution appropriate for the device and/or transmission link, for example, a cellular phone with a small low resolution screen may present the image in downscaled higher quantization layer (e.g., only spatially compressed), which fits the screens resolution. Additionally, in some embodiments of the invention, the image may be transmitted (or presented) progressively, that is, a low quality layer is transmitted and/or presented in a short time (such as 5%-15% of the high quality layer). In case the viewer prefers a better quality, an image of higher quality layer (of lower quantization) is constructed from the decoded difference frames (P-frames) by adding the differences to the respective decoded base tiles (decoded I-frames) and the combined tiles are arranged in their respective position in the image which is subsequently transmitted and/or presented.

In some embodiments of the invention, the video devices are portable and optionally have limited bandwidth and memory. Video apparatus is (and most likely will be) optimized by the industry for small size and/or low energy consumption. Integrating still image compression with minimal changes, such as software modification or a small IC (as described above) in the video apparatus allows to store the compressed high resolution image in a small memory and/or to send the image in high quality while consuming a small amount of a battery capacity and/or bandwidth.

Since a typical video encoder (present and/or future) comprises a processor, it would be appreciated by an ordinary person in the art and/or electronic industry and/or software industry how to modify the code of the encoder to augment it for the still image compression, optionally allocating and/or adding a memory for the still image compression.

It should be noted that in some embodiments of the invention, adapting the existing video apparatus for still image compression does not affect the regular video operations of the device, such as video capture or encoding or video recording

### Encoding According to Entropy Deficiency

In some embodiments of the invention the tiles complexity is determined (e.g., standard deviation of the pixels values) and the processor sets the encoder to a quantization factor responsive to the tile complexity, or corresponding entropy deficiency. The entropy deficiency of a tile (or corresponding complexity) enables to determine a quantization factor adapted to the bit-rate of a communication link or desired compression ratio. According to the factor determination, tiles with low complexity are quantized with a low factor preserving small graduations in the image while tiles with a complexity above a certain complexity are quantized with a high factor yielding a high compression ratio so that high compression with good visual quality is achieved. The methods to determine the quantization factor are described, at least partially, in U.S. application Ser. No. 11/987,639 filed on Dec. 3, 2004 entitled “ENTROPY DEFICIENCY BASED IMAGE COMPRESSION”, and in a PCT application attorney docket No. 37636 entitled “ENTROPY DEFICIENCY BASED IMAGE COMPRESSION”, the disclosures of which is incorporated herein by reference.

### D1

D1 is a resolution standard (optionally with some variations) for TV and similar devices.

In the NTSC system, a Full D1 is 720×480 pixels, and in the PAL and SECAM systems a full D1 is 720×576. Other resolutions are often described in terms of D1, for example, the SVCD resolution is 2/3D1 (480×NN) and 1/2 D1 is 352×NN (where NN is the number of rows). From http://tangentsoft.net/video/glossary.html, the disclosure of which is incorporated herein by reference.

### General

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As used herein, the terms “comprises”, “comprising”, “includes”, “including”, “having” and their conjugates mean “including but not limited to”. The term “consisting of means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a procedure” or “at least one procedure” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

The present invention has been described using detailed descriptions of embodiments thereof that are provided by way of example and are not intended to necessarily limit the scope of the invention. The described embodiments comprise different features, not all of which are required in all embodiments of the invention. Some embodiments of the invention utilize only some of the features or possible combinations of the features. Alternatively and additionally, portions of the invention described/depicted as a single unit may reside in two or more separate physical entities which act in concert to perform the described/depicted function. Alternatively and additionally, portions of the invention described/depicted as two or more separate physical entities may be integrated into a single physical entity to perform the described/depicted function. Variations of embodiments of the present invention that are described and embodiments of the present invention comprising different combinations of features noted in the described embodiments can be combined in all possible combinations including, but not limited to use of features described in the context of one embodiment in the context of any other embodiment.

1. A method for compressing an image in a sequence of pseudo-video frames of a lower resolution than the image, comprising:
(a) providing a video encoder fit for at least one of a spatial or temporal compression;
(b) providing an image;
(c) dividing the image into a plurality of partitions; and
(d) encoding the partitions into pseudo-video frames by the encoder.

2. A method according to claim 1, wherein at least one of a spatial or temporal compression comprises a spatial and temporal compression.

3. A method according to claim 1, wherein dividing comprises using a processor to divide the image.

4. A method according to claim 3, wherein the processor comprises at least a part of the encoder.

5. A method according to claim 3, wherein the encoder and the processor comprise a part of an integrated circuit.

6. A method according to claim 5, wherein the integrated circuit comprises an existing video compression apparatus or part thereof.

7. A method according to claim 5, wherein the integrated circuit comprises a system-on-a-chip.

8. A method according to claim 5, wherein the integrated circuit comprises a commercially available video compression apparatus or part thereof.

9. A method according to claim 1, wherein the encoder is compliant with at least one of H.264, MPEG1, MPEG2, MPEG4, DivX, VP, QT, WM or VC scheme or other standard scheme.

10. A method for integration of an image compression functionality in at least one of an apparatus or a design for video encoding of frames of a lower resolution than the image, comprising:
(a) providing a video encoding apparatus comprising a processor configured to execute a program; and
(b) modifying the apparatus to facilitate compression of a still image by the apparatus.

11. A method according to claim 10, wherein modifying comprises modifying the program for the image compression.

12. A method according to claim 10, wherein modifying comprises adding a code for the image compression.

13. A method according to claim 10, wherein modifying comprises modifying pathways of data.

14. A method according to claim 10, wherein modifying comprises modifying a memory allocation.

15. A method according to claim 10, wherein modifying comprises at least one of adding an element, changing an element, deleting an element or replacing an element.

16. A method according to claim 10, wherein modifying maintains the original video compression functionality of the apparatus.

17. A method according to claim 10, wherein the apparatus is a part of a system-on-a-chip.

18. A method according to claim 10, wherein at least the apparatus or the design is compliant with at least one of H.264, MPEG1, MPEG2, MPEG4, DivX, VP, QT, WM or VC scheme or other video standard scheme.

19. A method according to claim 10, wherein the apparatus is a part of at least one of a cellular phone, a handset a camera, a scanner or any device capable of image acquisition.

20. A method for integration in a video decoder a functionality for decompression an image compressed in frames of a pseudo-video sequence, comprising:
(a) providing a video decoder comprising a stored programming code; and
(b) modifying the code to facilitate image decompression from decoded video frames.

21. A method according to claim 20, wherein modifying the code comprises adding a code for managing the decoder operation.

22. A method according to claim 20, wherein modifying the code comprises adding a code for identifying frame characteristics.

23. A method according to claim 20, wherein modifying the code comprises adding a code for constructing a decompressed image by tiling decoded frames.

24. A method according to claim 20, wherein the decoder is a design of a decoder.

25. A method according to claim 20, wherein the decoder is an existing a decoder.

26. An apparatus for image compression in a pseudo-video sequence of frames of a lower resolution than the image, comprising:
(a) a video encoder configured to encode at least spatially or temporally a plurality of pictures in a sequence of compressed frames;
(b) a processor configured to execute a stored program or a part thereof; and
(c) wherein the program is configured to compress the image by the encoder.

27. An apparatus according to claim 26, wherein the program comprises a code configured to divide the image into pictures in a structure suitable for encoding by the encoder.

28. An apparatus according to claim 27, wherein the structure comprises a resolution suitable for encoding by the encoder.

29. An apparatus according to claim 27, wherein the program comprises a code configured to provide the pictures to the encoder.

30. An apparatus according to claim 26, wherein the program comprises a code configured to encode by the encoder information related to the sequence of frames.

31. An apparatus according to claim 30, wherein the information is used for decompressing the image from the encoded pictures.

32. An apparatus according to claim 26, wherein the apparatus comprises a system-on-a-chip.

33. An apparatus according to claim 26, wherein the encoder is compliant with at least one of H.264, MPEG1, MPEG2, MPEG4, DivX, VP, QT, WM or VC scheme or other video standard scheme.

34. An apparatus according to claim 26, wherein the apparatus is configured for video recording.

35. An apparatus according to claim 26, wherein the apparatus is at least implemented or suitable for implementation in a mobile device.

36. An apparatus according to claim 26, wherein the apparatus is a part of at least one of a cellular phone, a handset, a camera, a scanner or any device capable of image acquisition.

37. An apparatus according to claim 26, wherein the apparatus comprises an apparatus for image decompression of an image compressed in a pseudo-video sequence of frames of a lower resolution than the image.

38. An apparatus for image decompression of an image compressed in a pseudo-video sequence of frames of a lower resolution than the image, comprising:
(a) a video decoder configured to decode frames into pictures from a pseudo-video sequence of compressed frames;
(b) a processor configured to execute a stored program or a part thereof; and
(c) wherein the stored program is configured to decompress the image by the decoder.

39. An apparatus according to claim 38, wherein the program comprises code to decode frames into pictures by the decoder.

40. An apparatus according to claim 38, wherein the program comprises code to decode frames into pictures by the decoder.

41. An apparatus according to claim 40, wherein the program comprises code to construct the pictures into a decompressed image.

42. An apparatus according to claim 41, wherein the image is constructed based on information extracted from the pseudo-video sequence of compressed frames.

43. An apparatus according to claim 38, wherein the apparatus comprises a system-on-a-chip.

44. An apparatus according to claim 38, wherein the apparatus is at least implemented or suitable for implementation in a mobile device.

45. An apparatus according to claim 38, wherein the apparatus is configured for video display.

46. An apparatus according to claim 38, wherein the apparatus is at least implemented or suitable for implementation in a mobile device.

47. An apparatus according to claim 38, wherein the apparatus is a part of at least one of a cellular phone, a handset, a camera, a scanner or any device capable of image acquisition.

48. An apparatus according to claim 38, wherein the apparatus comprises an apparatus for image compression in a pseudo-video sequence of frames of a lower resolution than the image.

49. An apparatus according to claim 38, wherein the decoder is compliant with at least one of H.264, MPEG1, MPEG2, MPEG4, DivX, VP, QT, WM or VC scheme or other video standard scheme.
